(19) United States
(12) Patent Application Publication
(10) Pub. No.: US 2014/0117682 A1
(43) Pub. Date: May 1, 2014

(54) VEHICLE LOCKING SYSTEM

(71) Applicants: Jeffrey L. Konchan, Romeo, MI (US); Frank J. Arabia, JR., Macomb, MI (US)

(72) Inventors: Jeffrey L. Konchan, Romeo, MI (US); Frank J. Arabia, JR., Macomb, MI (US)

(73) Assignee: GM Global Technology Operations LLC, Detroit, MI (US)

(21) Appl. No.: 13/660,541

(22) Filed: Oct. 25, 2012

(51) Int. Cl. E05B 65/20

(52) U.S. Cl. 292/336.3

(57) ABSTRACT

Select variations may include a vehicle door locking system, which may have a vehicle door, a latch, a knob, a conduit an attachment, and a cable. The cable may extend through the conduit and connects the latch to the knob. The conduit may be connected only to the vehicle door but not to the latch or the knob.

### TECHNICAL FIELD

The technical field generally relates to locking systems, components, and methods of making and using the same.

### BACKGROUND

Fannon et al., U.S. Pat. No. 7,225,702, issued Jun. 5, 2007, in the Abstract states that it discloses “a cable end fitting retainer assembly for a vehicle includes a conduit end fitting for connection to a flexible cable.”

### SUMMARY OF SELECT ILLUSTRATIVE VARIATIONS OF THE INVENTION

One variation may include a product which may include a

vehicle door locking system. The vehicle door locking system may include vehicle door, a latch, a knob, a conduit, an attachment, and a cable. The cable may connect the latch to the knob and extend through the conduit. The conduit may be connected by the attachment to the vehicle door only and not to the latch or the Knob.

Another variation may include a product which may include a door locking system. The door locking system may include a door, a knob, a latch, an actuator, a rod, and a cable subassembly. The rod may connect the actuator to the latch. The cable subassembly may include a cable, a conduit, and an attachment. The cable may connect the latch to the knob. The conduit may only attach to the door and not to the latch, knob, actuator, or rod.

Another variation may include a product which may include a vehicle door, a latch, a knob, a plurality of conduits, a plurality of attachments, and a cable. The cable may connect the latch to the knob and extend through the plurality of conduits. The conduits may be connected by the plurality of attachments to the vehicle door only and not to the latch or the knob.

Other variations of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Variations of the invention will become more fully understood from the detailed description and the accompanying drawings, wherein:

FIG. 1 is a side view of one variation of a vehicle door locking system.

FIG. 2 is a side view similar to FIG. 1, showing another variation of a vehicle door locking system.

FIG. 3 is a side view similar to FIG. 1, showing one variation of a vehicle door locking system comprising plurality of conduits according to one variation of the invention.

### DETAILED DESCRIPTION OF SELECT VARIATIONS

The following description of the variation(s) is merely illustrative in nature and is in no way intended to limit the invention, its application, or uses.

The figures illustrate exemplary embodiments of a vehicle door locking system 10, which may reduce thickness of the locking system to increase occupant room inside a vehicle. The vehicle door locking system 10 may be any of a variety of types including, but not limited to a manual, power, child safety locking or may be another type. The vehicle door locking system 10 may also, among other things, be updated, implemented, or modified with minimal invasiveness to its various components because there is no additional latch 12, and knob 14 variant fittings required for attachment to a conduit 16. Although the vehicle door locking system 10 is shown and described with a cable 20 connecting the latch 12 and knob 14, the vehicle door locking system 10 may have other configurations and arrangements including, but not limited to, a rod 46 connecting the latch 12 and knob 14 with the conduit 16 surrounding a portion of the rod 46 in the radial direction.

Referring to FIG. 1, select variations may include a latch 12 which may be used to lock a vehicle door 26. The vehicle door 26 may be made of a made of a polymeric material, metallic material, and/or other similarly functioning materials. The vehicle door 26 may be conventional, suicide, scissor, butterfly, gull-wing, sliding, canopy, or may be another type. The latch 12 may be attached to the vehicle door 26 and a vehicle door handle 28, and may have more, less, and/or different components than those shown and described. The latch 12 may be made of a polymeric material or metallic material and/or other similarly functioning materials. The vehicle door handle 28 may be used to open and shut a vehicle door 26 and may be capable of push or pull opening and/or may be another type. The vehicle door handle 28 may be made of a polymeric material or metallic material and/or other similarly functioning materials. The knob 14 may be on the interior of the vehicle door 26 and may be used for manual locking and unlocking of the vehicle door locking system 10. The knob 14 may be made of a polymeric material or metallic material and/or other similarly functioning materials. The knob 14 may be on the top of the vehicle door 26 or on the interior wall 48 of the vehicle door 26, or may be in a different location on the vehicle door 26. The knob 14 and vehicle door 26 may have more, less, and/or different components than those shown and described.

Still referring to FIG. 1, a cable 20 may be used to connect the latch 12 and the knob 14 in the vehicle door locking system 10. The cable 20 may be made of a single strand of polymeric-material, metallic material, textile material, and/or other similarly functioning materials. The cable 20 may also be made of a plurality of strands of polymeric material, metallic material, textile material, and/or other similarly functioning materials. A conduit 16 may enclose the cable 20 radially along a portion of the cable. The conduit 16 may be made of a polymeric, fiber, clay or metallic material and/or other similarly functioning materials. The conduit 16 may be flexible or rigid. Select variations of conduits 16 include, but are not limited to, PVC, Flexible Metallic Tubing, or Rigid Metal Conduit. The cable 20 may be a push-pull cable that is rigid for movement against the latch 12. An attachment 34 may attach the conduit 16 to the interior wall of the vehicle door 48. The attachment may be a clip, tongue and groove, screw, nail, joint, or may be another type. The attachment 34 may be made of a polymeric material fibrous material, textile material or metallic material and/or other similarly functioning materials. The conduit 16 may have a lubricating material applied along its length to aid in the axial movement of the cable 20 within the conduit 16. This variation may eliminate the need for conduit fittings. The vehicle door locking system 10 may in select variations increase occupant room inside the vehicle as the thickness of the vehicle door locking system 10 may be reduced.

Still referring to FIG. 1, an actuator 36 may be provided and may control the latch 12. The actuator 36 may contain a thin rod 38 that may connect to the latch 12. The thin rod 38 may be made of a polymeric material or metallic material and/or other similarly functioning materials. When the actuator 36 moves the latch 12 up, it may connect the vehicle door handle 28 to the latch for opening the vehicle door 26. In other words, the vehicle door 26 is placed in an unlocked position. When the actuator 36 moves the latch 12 down, the vehicle door handle 28 may be disconnected from the latch so the vehicle door 26 cannot be opened by the vehicle door handle 28. In other words, the vehicle door 26 is placed in a locked position. The actuator 36 may have power supplied to it for moving from a locked to an unlocked position via manual force or electrical power.

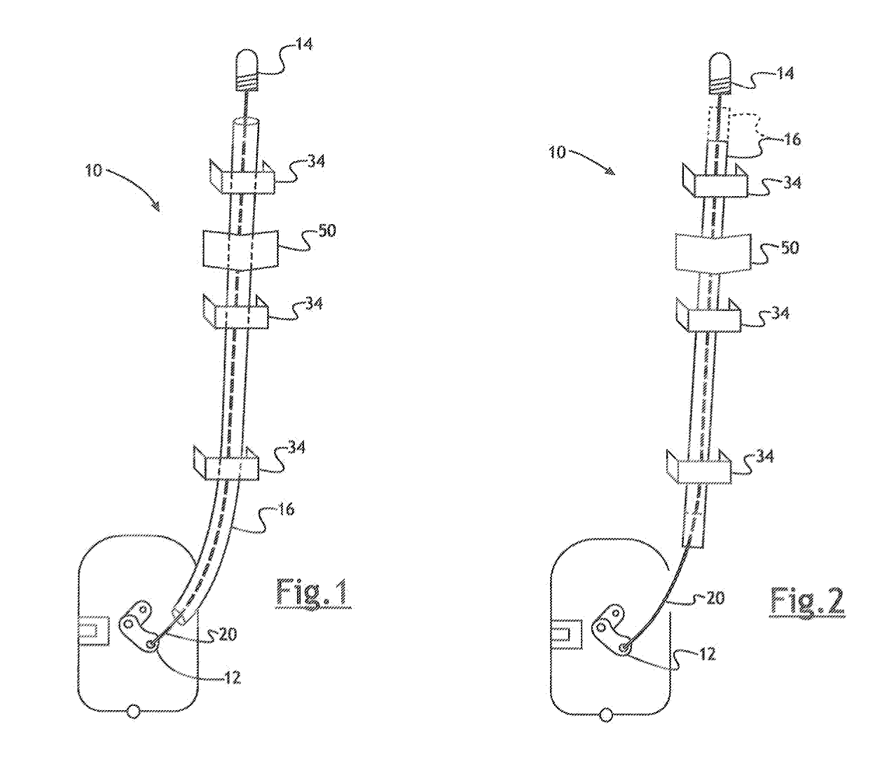

For other variations, shown in FIG. 2, the latch 12 may be connected directly to the cable 20, where the conduit 16 may be attached to the interior wall 48 of the vehicle door 26 between the latch 12 and the knob 14 by the attachment 34. This variation may eliminate the need for conduit fittings. The conduit 16 may be of differing length along the cable 20 and may be placed anywhere along the length of the cable 20. The free placement of the conduit 16 may, in select variations, eliminate excess cable 20 causing the locking system 10 to stop working properly and in some cases a partial actuation. An attachment 34 may attach the conduit 16 directly to the interior wall 48 of the vehicle door 26 or to anywhere located on the vehicle door 26. For select variations, attachment may be, but is not limited to, a clip, tongue and groove, screw, nail, joint or may be another type. The attachment 34 may be made of a polymeric material, fibrous material, textile material or metallic material and/or other similarly functioning: materials. The conduit 16 may have a lubricating material applied along its length to aid in the axial movement of the cable 20 within the conduit 16.

Referring to FIG. 2, in other select variations of the vehicle door locking system 10, the conduit 16 may be place at various positions along the cable 20 between the latch 12 and the knob 14. The length of cable 20 may not be critical to the function of the conduit 16 because the conduit 16 may be placed anywhere along the length of the cable 20 in the axial direction. The conduit 16 may have a lubricating material applied along its length to aid in the axial movement of the cable 20 within the conduit 16.

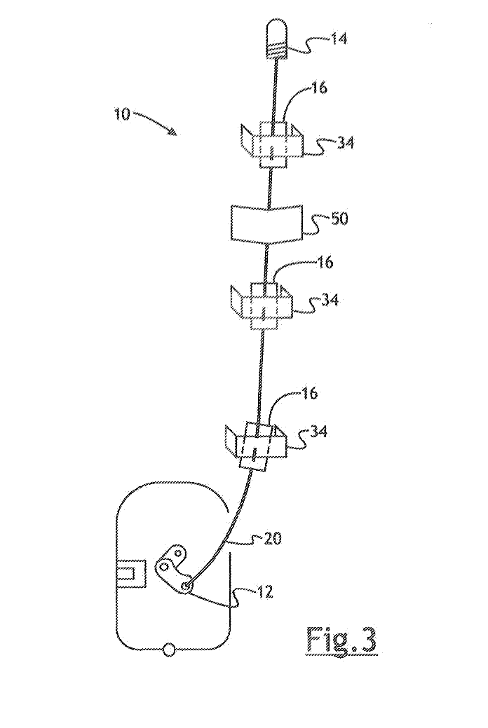

Referring to FIG. 3, in other select variations a plurality of conduits 16 may be placed along the length of the cable 20. The plurality of conduits 16 may minimize the materials used in the vehicle door locking system 10. The plurality of conduits 16 may be made of a polymeric material, a metallic material, ceramic material, natural material such as wood, and/or other similarly functioning materials. The plurality of conduits 16 may be flexible or rigid. In select variations the plurality of conduits 16 may include PVC, flexible Metallic Tubing, or Rigid Metal Conduit. These variations are not intended to limit the type of conduit in any way. The plurality of conduits 16 may be placed anywhere along the length of the cable 20 in the axial direction. A plurality of attachments 34 may attach one or more of the plurality of conduits 16 to the interior wall 48 of the vehicle door 26 directly. In select variations the plurality of attachments 34 may be, but are not limited to, a clip, tongue and groove, screw, nail, joint, or may be another type. The plurality of attachments 34 may be made of a polymeric material, fibrous material, textile material or metallic material and/or other similarly functioning materials. The plurality of conduits 16 may have a lubricating material applied along its length to aid in the axial movement of the cable 20 within the plurality of conduits 16.

In any of the above-described variations, a damper 50 may be

located radially around the conduit 16 or the cable 20 or both, and may dampen vibrations between the conduit 16, cable 20, and/or the vehicle door 26. In one variation, the damper 50 may be placed around the conduit 16 for dampening vibrations, in another variation, the damper 50 need not be located in a set position along the conduit 16, but may slide freely along the length of the conduit 16, or cable 20, or both in the radial direction. The damper 50 may be made of material for damping vibrations and preventing or reducing noise such as, but not limited to, a polymeric material or rubber material and/or similarly functioning materials. The damper may be in the form of an adhesive or foam or another similarly functioning form.

Further, in any of the above-described embodiments, the vehicle door locking system 10 may be implemented to existing locking technology without changes to the latch 12, knob 14, or actuator 36.

The following numbered variations are illustrative only and are not intended to limit the scope of the invention or any claim thereof to the numbered variations as specifically described. The numbered variations and any other variation described herein may include components, elements or acts that may individual be combined with other described components, elements or acts in any of variety of combinations and in any of a variety of physical and functional relationships with respect to each other.

Variation 1 may include a product that may include; a vehicle door locking system comprising a vehicle door, a latch, a knob, a conduit, an attachment, and a cable; and the cable extending through the conduit and connected to the latch and to the knob, and the conduit connected to the vehicle door but not to the latch or the knob.

Variation 2 may include a product as set forth in any of variations 1 or 11 further comprising: a damper located between the vehicle door and the conduit or cable to damp vibrations therein.

Variation 3 may include a product as set forth in any of variations 1-2 or 11 further comprising: a door handle on the vehicle door for opening and closing of the vehicle door.

Variation 4 may include a product as set forth in any of variations 1-3 or 11 further comprising: an actuator.

Variation 5 may include a product as set forth in any of variations 1-4 or 11 wherein the attachment comprises at least one of polymeric material, fibrous material, textile material or metallic material.

Variation 6 may include a product as set forth in any of variation 1-5 or 11 wherein the damper comprises foam or adhesive.

Variation 7 may include a product as set forth in any of variations 1-8 or 11 wherein the actuator or knob moves the latch either up or down to lock or unlock the vehicle door.

Variation 8 may include a product as set forth in any of variations 1-8 or 11 wherein the conduit comprises at least one of a polymeric, fiber, clay, natural or metallic material.

Variation 9 may include a product as set forth in any of variations 1-8 or 11 wherein the cable comprises a single strand of polymeric material, metallic material or textile material.

Variation 10 may include a product as set forth in variations 1-10 or 11 wherein the cable comprises a plurality of strands strand of polymeric material, metallic material or textile material.

Variation 11 may include a product comprising: a door locking system comprising a door, a knob, a latch, an actuator, a rod connecting the actuator to the latch, and a cable subassembly comprising a cable, a conduit, and an attachment, wherein the cable connects the latch to the knob and the attachment connects the conduit only to the door and not to the latch, knob, actuator, or rod.

Variation 12 may include a product as set forth in any of variations 1 or 11 further comprising: a damper located between the vehicle door and the conduit or cable to damp vibrations therein.

Variation 13 may include a product as set forth in any of variations 1 or 11-12 wherein the conduit comprises a polymeric, fiber, ceramic, natural or metallic material.

Variation 14 may include a product as set forth in any of variations 1 or 11-13 wherein the cable comprises a single strand of polymeric material, metallic material or textile material.

Variation 15 may include a product as set forth in any of variations 1 or 11-14 wherein the cable comprises a plurality of strands of polymeric material, metallic material or textile material.

Variation 16 may include a product comprising; a vehicle door locking system comprising a vehicle door, a latch, a knob, a plurality of conduits, a plurality of attachments, and a cable; and the cable extending through the plurality of conduits and connected to the latch and to the knob, and the plurality of conduits connected to the vehicle door by the plurality of attachments but not to the latch or the knob.

Variation 17 may include a product as set forth in any of variations 1-11 or 16 further comprising: a damper located between the vehicle door and the conduit or cable to damp vibrations therein.

Variation 18 may include a product as set forth in any of variations 1-11 or 16-17 wherein the conduit comprises a polymeric, fiber, ceramic, natural or metallic material.

Variation 19 may include a product as set forth in any of variations 1-11 or 16-18 wherein the cable comprises a single strand of polymeric material, metallic material or textile material.

Variation 120 may include a product as set forth in any of variations 1-11 or 16-19 wherein the cable comprises a plurality of strands of polymeric material, metallic material or textile material.

The above description of embodiments of the invention is merely exemplary in nature and, thus, variations thereof are not to be regarded as a departure from the spirit and scope of the invention.

What is claimed is:

1. A product comprising;
a vehicle door locking system comprising a vehicle door, a latch, a knob, a conduit, an attachment, and a cable; and
the cable extending through the conduit and connected to the latch and to the knob, and the conduit connected to the vehicle door but not to the latch or the knob.

2. A product as set forth in claim 1 further comprising:
a damper located between the vehicle door and the conduit or cable to damp vibrations therein.

3. A product as set forth in claim 1 further comprising:
a door handle on the vehicle door for opening and closing of the vehicle door.

4. A product as set forth in claim 1 further comprising:
an actuator.

5. A product as set forth in claim 1 wherein the attachment comprises at least one of polymeric material, fibrous material, textile material or metallic material.

6. A product as set forth in claim 1 wherein the damper comprises foam or adhesive.

7. A product as set forth in claim 1 wherein the actuator or knob moves the latch either up or down to lock or unlock the vehicle door.

8. A product as set forth in claim 1 wherein the conduit comprises at least one of a polymeric, fiber, clay, natural or metallic material.

9. A product as set forth in claim 1 wherein the cable comprises a single strand of polymeric .material, metallic material or textile material.

10. A product as set forth in claim 1 wherein the cable comprises a plurality of strands strand of polymeric material, metallic material or textile material.

11. A product comprising:
a door locking system comprising a door, a knob, a latch, an actuator, a rod connecting the actuator to the latch, and a cable subassembly comprising a cable, a conduit, and an attachment, wherein the cable connects the latch to the knob and the attachment connects the conduit only to the door and not to the latch, knob, actuator, or rod.

12. A product as set forth in claim 11 further comprising:
a damper located between the vehicle door and the conduit or cable to damp vibrations therein.

13. A product as set forth in claim 11 wherein the conduit comprises a polymeric, fiber, ceramic, natural or metallic material.

14. A product as set forth in claim 11 wherein the cable comprises a single strand of polymeric material, metallic material or textile material.

15. A product as set forth in claim 11 wherein the cable comprises a plurality of strands of polymeric material, metallic material or textile material.

16. A product comprising:
a vehicle door locking system comprising a vehicle door, a latch, a knob, a plurality of conduits, a plurality of attachments, and a cable; and
the cable extending through the plurality of conduits and connected to the latch and to the knob, and the plurality of conduits connected to the vehicle door by the plurality of attachments but not to the latch or the knob.

17. A product as set forth in claim 16 further comprising:
a damper located between the vehicle door and the conduit or cable to damp vibrations therein.

18. A product as set forth in claim 16 wherein the conduit comprises a polymeric, fiber, ceramic, natural or metallic material.

19. A product as set forth in claim 16 wherein the cable comprises a single strand of polymeric material, metallic material or textile material.

20. A product as set forth in claim 16 wherein the cable comprises a plurality of strands of polymeric material, metallic material or textile material.
